(19) United States
(12) Patent Application Publication
(10) Pub. No.: US 2011/0274844 A1
(43) Pub. Date: Nov. 10, 2011

(54) AGENT FOR THE TREATMENT OF TOP-COAT PAINT FILMS TO IMPART STAIN RESISTANCE AND A METHOD FOR THE TREATMENT OF TOP-COAT PAINT FILMS TO IMPART STAIN-RESISTANCE

(75) Inventors: Kishio Shibato, Kanagawa (JP); Tsuyoshi Shinjo, Kanagawa (JP); Takeshi Nomoto, Kanagawa (JP)

(73) Assignee: BASF COATINGS JAPAN LTD., Yokohama (JP)

(21) Appl. No.: 12/744,169

(22) PCT Filed: Oct. 22, 2008
(86) PCT No.: PCT/IB08/02859

§ 371 Date: Aug. 6, 2010

(30) Foreign Application Priority Data
Nov. 22, 2007 (JP) 2007-302612

(51) Int. Cl. B05D 7/24; B05D 3/00; C09D 5/00

(52) U.S. Cl. 427/384; 106/2

(57) ABSTRACT

An agent for imparting stain resistance to a top-coat paint film that has (a) from 3 to 10 mass % of a compound represented by Formula (1) or a partial hydrolysis condensate thereof, wherein Formula (1) is R¹—(OCH₂CH₂)ₙ—O—Si(OR²)₃ wherein R¹ is an alkyl group having 1 to 6 carbon atoms or a hydrogen atom, R² is the same or different and is an alkyl group having 1 to 6 carbon atoms, and n is an integer value from 2 to 4, (b) from 0.01 to 1 mass % of a catalyst with which the aforementioned (a) component can be hydrolyzed, (c) 0.5 to 3 mass % of an alkylsulfosuccinic acid salt based surfactant, and (d) from 86 to 96.49 mass % of an alcohol based solvent which has not more than 3 carbon atoms. A method for imparting stain resistance to a top-coat paint film employing the disclosed agent is also provided.

An agent for the treatment of top-coat paint films to impart stain resistance and a method for the treatment of top-coat paint films to impart stain-resistance

### TECHNICAL FIELD

The invention concerns an agent for the treatment of top-coat paint films to impart stain resistance which is coated onto painted products which have been painted with a top-coat paint such as automobile bodies, automobile bumpers and the like, and a method for the treatment of top-coat paint films to impart stain resistance.

### TECHNICAL BACKGROUND

In the past when staining occurred as an automobile was being driven along in general it was usually returned to the original beautiful state by washing the vehicle and applying a water-repelling wax. However, in recent years the amount of detergent being used by car-washing has increased and this has resulted in a decline in the water-quality of sea, river, lake and marsh water. Furthermore, the water-repelling waxes are often oily and these are not only a similar cause of water contamination but also tend to facilitate the deposition of oily stains since they make the paint film lipophilic. Consequently most recently the idea of introducing water between the staining material and the paint film by rendering the paint film hydrophilic has been promoted so that the staining material floats on the surface and there is a stain-resisting function (see Non-patent Citation 1).

Paint compositions where specified organosilicates and/or condensates thereof in a specified organic paint composition and the provision of paint films where the angle of contact of water on the paint film after acid treatment is not more than 70° are known as actual methods of rendering a paint film hydrophilic (see Patent Citation 1). However, although the paint films themselves are certainly hydrophilic and a stain resisting function can be achieved, a layer of a condensate of the silicate is present on the hardened paint film surface and so recoating adhesion is reduced and there is a major problem in that retouching is not possible during factory production.

Furthermore, there is a method in which a photo-catalytic coating is coated on a base-material surface to impart a high degree of hydrophilicity (see Patent Citation 2). When irradiated with light the paint film can be rendered highly hydrophilic, but when shielded from light for long periods such as at night or in a garage for example the effect declines and disappears and so this cannot be said to be a satisfactory method.

Moreover, there is a method in which a hydrolysis treatment is carried out after coating a mixture made up of alkylsilicate modified material and hydrolysis catalyst on a top-coat paint film in order to impart a stain resisting function (see Patent Citation 3). However, this method requires the execution of a hydrolysis treatment after applying the mixture which is made up of alkylsilicate modified material and hydrolysis catalyst and it is difficult to apply to materials which have a complicated shape and large objects.

### [Non-patent Citation 1]

Toso Gijutsu 1996, October Special Number, pages 87-102

### [Patent Citation 1]

International Document Laid Open WO94/06870

### [Patent Citation 2]

International Document Laid Open WO97/23572

### [Patent Citation 3]

Japanese Unexamined Patent Application Laid Open 2000-328005

### DISCLOSURE OF THE INVENTION

### Problems to be Resolved by the Invention

The present invention provides an agent for the treatment of a top-coat paint to impart stain resistance with which a stain resisting function can be imparted easily to a top-coat paint film which is the outermost paint film irrespective of the type or history of the top-coat paint film and with which a clean paint film can be maintained over a long period of time, and a method for the treatment of a top-coat paint film to impart stain resistance.

### Means of Resolving these Problems

As a result of thorough research carried out with a view to rendering top-coat paint films hydrophilic in a stable manner and imparting a stain resisting function without any obstruction of conventional paint-film repair in factory production the inventors have discovered that the abovementioned problems can be resolved by coating an agent for a treatment which imparts stain resistance which contains in specified proportions a specified silicone compound, hydrolysis catalyst, alkylsulfosuccinic acid salt based surfactant and alcohol based solvent which has not more than 3 carbon atoms on the top-coat paint film after said top-coat paint film, including repair processes, has been completed, and leaving this to dry naturally, and the invention is based upon this discovery.

That is to say, the invention provides an agent for the treatment of a top-coat paint film to impart stain resistance which includes (a) from 3 to 10 mass % of a compound which can be represented by the formula (1) which is indicated below or a partial hydrolysis condensate thereof, (b) from 0.01 to 1 mass % of a catalyst with which the aforementioned (a) component can be hydrolyzed, (c) from 0.5 to 3 mass % of an alkyl-sulfosuccinic acid salt based surfactant and (d) from 86 to 96.49 mass % of an alcohol based solvent which has not more than 3 carbon atoms.

Formula (1)

R¹—(OCH₂CH₂)ₙ—O—Si(OR²)₃ (1)

(In this formula R¹ is an alkyl group which has from 1 to 6 carbon atoms or a hydrogen atom, R² is an alkyl group which has from 1 to 6 carbon atoms, and the three R² may be the same or different. Moreover n is an integer value from 2 to 4.)

Furthermore, the invention provides a method for the treatment of top-coat paint films to impart stain resistance in which the abovementioned agent for the treatment of top-coat paint films to impart stain resistance is coated onto the top-coat film of a painted product and dried naturally.

### Effect of the Invention

With the method for the treatment of a top-coat paint film to impart stain resistance of this invention it is possible to establish easily a strongly bound hydrophilic layer on the outermost paint film irrespective of the type or history of the top-coat paint film and a stain resisting function can be imparted. Thus a clean paint film can be maintained over a long period of time and, by reducing the number of times the car is washed, it is possible to reduce considerably the amount of environmental pollution which is caused by detergent.

### EMBODIMENT OF THE INVENTION

The (a) component which is used in the invention is hydrolyzed by means of the hydrolysis catalyst which is the (b) component with water in the atmosphere after the agent for treatment to impart stain resistance has been coated and used to form a strong hydrophilic three-dimensional network structure on the surface of the top-coat paint film. The (a) component is a compound which can be represented by the formula (1) which is indicated below, or a partial hydrolyzed condensate thereof.

R¹—(OCH₂CH₂)ₙ—O—Si(OR²)₃ Formula (1)

(In this formula R¹ is an alkyl group which has from 1 to 6 carbon atoms or a hydrogen atom, R² is an alkyl group which has from 1 to 6 carbon atoms, and the three R² may be the same or different. Moreover n is an integer value from 2 to 4.)
The (a) component may be one or more type of compound which can be represented by formula (1), one or more type of partial hydrolysis condensate thereof, or one or more type of each used conjointly.

The (a) component can be obtained in practical terms by reacting a compound which can be represented by the formula R^{1a}—(OCH₂CH₂)ₙ—OH (where R^{1a} is an alkyl group which has from 1 to 6 carbon atoms and n has the same significance as before) with a compound which can be represented by the formula Si(OR²)₄ (where R² has the same significance as before and the four R² may be the same or different) or a partial hydrolysis condensate thereof.

Examples of Si(OR²)₄ include tetramethoxysilane, tetraethoxysilane, tetrapropoxysilane, tetraisopropoxysilane, tetrabutoxysilane, tetraisobutoxysilane and the like, and the partial hydrolysis condensates obtained by partially hydrolyzing one of these individually or two or more types in combination can be cited as examples of their partial hydrolysis condensates. One of these may be used alone or two or more types can be used in combination.

Compounds which can be represented by the formula R^{1a}—(OCH₂CH₂)ₙ—OH include diethylene glycol, triethylene glycol, tetraethylene glycol, diethylene glycol mono-methyl ether, triethylene glycol mono-methyl ether, tetraethylene glycol mono-methyl ether and the like, and one of these can be used alone or two or more types can be used in combination.

The reaction of the compound represented by the formula R^{1a}—(OCH₂CH₂)ₙ—OH with the abovementioned compound which can be represented Si(OR²)₄ may be achieved by carrying out an alcohol-exchange reaction under mild conditions from room temperature to 100° C. in the presence of a comparatively strong organic acid such as a sulfonic acid, for example, p-toleuensulfonic acid, dodecylbenzenesulfonic acid, dinonylnaphthalenesulfonic acid, dinonylnaphthalenedisulfonic acid or the like, or a phosphoric acid ester. If at this time the reaction temperature is below room temperature the progress of the alcohol-exchange reaction is slow, and if the reaction temperature exceeds 100° C. then the alcohol-exchange reaction proceeds rapidly and it is possible that gelling will also occur as a result of condensation reactions between alkoxy groups and so these situations are undesirable. Furthermore, a small amount of water may be present during the alcohol-exchange reaction.

The (b) component, which is to say the catalyst by means of which the (a) component is hydrolyzed, which is used in this invention may be, for example, an organo-tin compound such as dibutyl-tin diacetate, dibutyl-tin dilaurate, dibutyl-tin dimaleate, tin di-octylate, dibutyl-tin oxide and the like, an organic acid such as p-toluenesulfonic acid, dodecyl-benzenesulfonic acid, dinonylnaphthalenesulfonic acid, dinonylnaphthalenedisulfonic acid, methanesulfonic acid and the like, or an amine such as triethylamine, dimethylbenzylamine, dimethylethanolamine, dimethyllaurylamine, dibutylamine, di-2-ethylhexylamine, tetramethylbutanediamine, pyridine, triethanolamine and the like.

The (c) component which is used in this invention is an alkylsulfosuccinic acid salt based surfactant, and it is used to provide hydrophilic properties immediately after applying the agent for a treatment which imparts stain resistance. Actual examples of the (c) component include sodium dihexylsulfosuccinate, potassium dihexylsulfosuccinate, ammonium dihexylsulfosuccinate, sodium dioctylsulfosuccinate, potassium dioctylsulfosuccinate, ammonium dioctylsulfosuccinate and the like.

The (d) component which is used in the invention is an alcohol based solvent which has from 1 to 3 carbon atoms and it is essential for coating the agent for a treatment to impart stain resistance in a uniform and transparent form. Methanol, ethanol, n-propanol and isopropanol can be cited as actual examples of the (d) component.

The proportions in which the (a), (b), (c) and (d) components which are used in the invention are included are as indicated below.

Thus (a)/(b)/(c)/(d) is from 3 to 10 mass %/from 0.01 to 1 mass %/from 0.5 to 3 mass %/from 86 to 96.49 mass %, and preferably (a)/(b)/(c)/(d) is from 4 to 8 mass %/from 0.03 to 0.5 mass %/from 1 to 2 mass %/from 90 to 94.97 mass %.

Here, if the (a) component is less than 3 mass % then the stain resisting function disappears in a short period of time and this is undesirable, and if there is more than 10 mass % then the stain resistant treated state becomes uneven and there is a decline in appearance and so this is undesirable.

If the (b) component is less than 0.01 mass % then it is impossible to realize the intended staining resistance satisfactorily because of inadequate hydrolysis of the (a) component, and if there is more than 1 mass % then the hydrolysis reaction of the (a) component proceeds rapidly and the state of the coated layer comprising the agent for a treatment to impart stain resistance which has been coated on the paint film becomes uneven and there are cases where cloudiness, cracking and the like arise and so this is undesirable.

Furthermore, with less than 0.5 mass % of the (c) component it is impossible a realize a satisfactory stain resisting function immediately after coating the agent for the treatment to impart stain resistance and so this is undesirable, and if there is more than 3 mass % then if exposure to rain, for example, occurs immediately after coating the agent for a treatment to impart stain resistance then the coated layer of said mixture is inevitably washed off and this is undesirable.

If the (d) component is less than 86 mass % then the result is liable to be uneven when the agent for a treatment to impart stain resistance is being coated and the appearance declines and so this is undesirable, and it there is more than 96.49 mass % then the stain resisting function disappears in a short period of time and this is undesirable.

An agent for the treatment of a top-coat paint film to impart stain resistance of this invention can be prepared by mixing the abovementioned (a), (b), (c) and (d) components together in the specified proportions indicated above.

In the method for the treatment of a top-coat paint film to impart stain resistance of this invention the coating of the agent for the treatment to impart stain resistance is carried out over the top-coat paint film of a painted object which has a top-coat paint film.

Examples of painted objects which have a top-coat paint film include a variety of painted objects such as automobile bodies and automobile parts such as bumpers, exterior decorative parts and the like. No particular limitation is imposed upon the material from which the base of the painted object is made and it may be, for example, a resin such as a polyolefin resin such as polyethylene resin, polypropylene resin, polystyrene resin and the like or an engineering plastic such as polyurethane resin, polyvinyl chloride resin, ABS resin, phenol resin, polycarbonate resin, polyamide resin, polyester resin or the like, or a metal such as iron, aluminum or the like. Moreover, any primer paint film, undercoat paint film or mid-coat paint film, or a combination of such paint films, can be established under the top-coat paint film of the painted object. No particular limitations are imposed upon the types and thicknesses of these paint films.

No particular limitation is imposed upon the type of top-coat paint film on the painted object and the top-coat paint films obtained by painting on various types of paint such as acrylic resin paints, epoxy resin paints, polyester resin paints, polyurethane resin paints, phenol resin paints, vinyl chloride resin paints, alkyd resin paints, fluorinated resin paints and the like can be cited as examples. Moreover, the top-coat paint film may be a repaired top-coat paint film.

Actual examples of the top-coat paint films include automobile body one-coat solid paint films, automobile body two-coat one-bake solid paint films, automobile body two-coat one-bake metallic paint films, automobile body two-coat one-bake pearl paint films, automobile body three-coat two-bake pearl paint films, automobile body three-coat one-bake pearl paint films and in-line and off-line repaired paint films of the above types, and also automobile bumper one-coat solid paint films, automobile bumper two-coat one-bake solid paint films, automobile bumper two-coat one-bake metallic paint films, automobile bumper two-coat one-bake pearl paint films, automobile bumper three-coat two-bake pearl paint films, automobile bumper three-coat one-bake pearl paint films and in-line and off-line repaired paint films of the above types.

Moreover, no particular limitation is imposed upon the thickness of the abovementioned top-coat paint films but a thickness of from 10 to 200 μm is generally preferred.

In the method for the treatment of a top-coat paint film to impart stain resistance of this invention the coating of the agent for a treatment to impart stain resistance on the top-coat film of painted object is not subject to any particular limitation such as the usual methods of spray painting, roller painting, brush painting, immersion painting and wipe-painting where paint is introduced on cloth, paper, sponge or the like, and the method can be selected in combination with the object which is to be coated. No particular limitation is imposed upon the temperature when the agent for a treatment to impart stain resistance is being coated, but coating is generally carried out at from 0 to 50° C.

The dry thickness of the coated layer of the agent for a treatment to impart stain resistance is preferably within the range from 0.01 to 1 μm. When the dry thickness of the coated layer of the agent for a treatment to impart stain resistance is less than 0.01 μm there are cases where which it is not possible to realize the intended stain resistance satisfactorily. Furthermore, when it exceeds 1 μm there are cases where clouding, cracking and the like occur. After coating the agent for a treatment to impart stain resistance in this invention it is dried naturally for a few minutes or more.

Furthermore, no particular limitation is imposed upon the timing of the coating of the agent for the treatment of a top-coat paint film to impart stain resistance of this invention over the top-coat paint film of an automobile and, for example, it can be coated immediately after the top-coat painting has been completed in the automobile production factory or when the automobile is being stored at an automobile sales outlet.

### Illustrative Examples

The invention is described in more practical terms below by means of illustrative examples, but the invention is not limited to being within the scope of these illustrative examples.

### [Production of Top-coat Painted Sheets]

A flat sheet of polypropylene for automobile bumper purposes was washed with water and dried naturally. Next Primac No. 1501 primer (a primer for resins produced by the BASF Coatings Japan Co.) was spray painted on the abovementioned flat sheet so as to provide a dry film thickness of from 5 to 7 μm. Then Primac No. 3000 white (a top-coat paint for resins produced by the BASF Coatings Japan Co.) was spray painted wet-on-wet on said primer in such a way as to provide a dry film thickness of from 30 to 35 μm and, after setting for 15 minutes at room temperature, a white top-coat painted sheet was obtained by baking for 30 minutes at an object temperature of 120° C.

### [Examples of the Production of (a) Components]

### Silicone Compound 1

Silicone Compound 1 which is an (a) component was obtained by introducing the mixture indicated below into a four-necked flask which had been furnished via a Dean and Stark trap with a reflux condenser, a thermometer and a stirrer, stirring at 80° C. and terminating the reaction when 46 parts by mass of ethanol had been recovered.

| | | |
|---|---|---|
| Tetraethoxysilane | 208 | parts by mass |
| Triethylene glycol mono-methyl ether | 164 | parts by mass |
| Dodecylbenzenesulfonic acid | 0.5 | part by mass |
| De-ionized water | 4.5 | parts by mass |

### Silicone Compound 2

Silicone Compound 2 which is an (a) component was obtained by introducing the mixture indicated below into a four-necked flask which had been furnished via a Dean and Stark trap with a reflux condenser, a thermometer and a stirrer, stirring at 80° C. and terminating the reaction when 32 parts by mass of ethanol had been recovered.

| | | |
|---|---|---|
| Tetraethoxysilane | 208 | parts by mass |
| Tetraethylene glycol mono-methyl ether | 208 | parts by mass |
| Dodecylbenzenesulfonic acid | 0.6 | part by mass |
| De-ionized water | 4.5 | parts by mass |

### Examples 1 to 4 and Comparative Examples 1 to 4

The components indicated in Table 1 were mixed in the compounding proportions shown in Table 1 and the agents for a treatment to impart stain resistance obtained were coated evenly using a sponge brush over the top-coat painted sheets which had been produced in the way indicated above and then dried naturally for 10 minutes at room temperature and top-coat painted sheets which had a coated layer of the agent for a treatment to impart stain resistance such that the dry film thickness of the coated layer of the agent for the treatment to impart stain resistance was within the range from 0.05 to 0.5 μm were obtained.

The angles of contact of water on the top-coat painted sheets which had a coated layer of agent for a treatment to impart stain resistance so obtained were measured and said top-coat painted sheets were exposed outdoors for 3 months at an angle of 45° facing north. The states of staining of the coated layers after 3 months outdoor exposure was assessed visually and with the brightness difference ΔL before and after the exposure test. The results are shown in Table 1.

Moreover, in the table Catalyst A is dibutyl-tin dialurate, Catalyst B is dodecylbenzenedsulfonic acid and the surfactant is sodium dioctylsulfosuccinate.

### [Methods of Evaluating the Coated Layer of Agent for a Treatment to Impart Stain Resistance]

### (1) Angle of Contact of Water

The angle of contact of water of the coated layer of an agent for the treatment to impart stain resistance was measured using a Model G1 produced by the Elmer Co. A smaller measured value indicates greater hydrophilicity.

### (2) State of Staining After Outdoor Exposure (State of Staining in the Unwashed State)

The state of staining of the coated layer of the agent for a treatment to impart stain resistance after being exposed outdoors was observed visually and evaluated on the basis of the criteria indicated below.

∘: Virtually no staining was observed
X: Staining was observed
XX: Marked staining was observed

### (3) State of Staining After Outdoor Exposure (State of Staining in the Unwashed State)

The state of staining of the coated layer of the agent for a treatment to impart stain resistance after being exposed outdoors was assessed by means of the ΔL value. The L-value was measured before and after exposure using a color difference meter (CR-331, produced by the Minolta Co.). The ΔL value was calculated by means of the following equation:

ΔL Value=L-Value Before Outdoor Exposure−L-Value after Outdoor Exposure

TABLE 1

| | | Example | | | | Comparative Example | | | |
|---|---|---|---|---|---|---|---|---|---|
| | | 1 | 2 | 3 | 4 | 1 | 2 | 3 | 4 |
| Composition | Silicone | 5 | | 4 | | 5 | | 5 | Not Coated |
| of the agent | Compound 1 | | | | | | | | with an |
| for treatment | Silicone | | 5 | | 8 | | 5 | | Agent for |
| for imparting | Compound 2 | | | | | | | | Imparting |
| stain | Catalyst A | 0.05 | | 0.03 | | | 0.05 | | Stain |
| resistance | Catalyst B | | 0.05 | | 0.7 | 5 | | | Resistance |
| | Surfactant | 1 | 1 | 0.7 | 2 | 2 | 0.1 | 1 | |
| | Ethanol | 93.95 | 93.95 | 95.27 | 89.3 | 88 | 94.85 | 94 | |
| Angle of Contact of | | 35 | 33 | 34 | 32 | 36 | 74 | 37 | 82 |
| Water (°) | | | | | | | | | |
| Appearance of the Coated | | No | No | No | No | Cloudiness | No | No | — |
| Part (Visual) | | Abnormality | Abnormality | Abnormality | Abnormality | | Abnormality | Abnormality | |
| State of staining after | | | | | | | | | |
| external exposure | | | | | | | | | |
| 1 Month | Visual | ◯ | ◯ | ◯ | ◯ | ◯ | X | ◯ | X |
| | ΔL Value | −0.8 | −1.0 | −0.9 | −1.1 | −1.3 | −5.8 | −1.2 | −7.4 |
| 3 Months | Visual | ◯ | ◯ | ◯ | ◯ | ◯ | ◯ | X | XX |
| | ΔL Value | −1.5 | −1.4 | −1.7 | −1.5 | −1.7 | −2.1 | −4.5 | −14.3 |

In Examples 1 to 4 there was no abnormality at all in the paint film appearance and in all cases an angle of contact of less than 40° was obtained and the paint films were clean even after being exposed for 3 months. On the other hand, in Comparative Example 1 cloudiness was produced in the treatment layer because there was too much of the hydrolysis catalyst (b) component. Furthermore, in Comparative Example 2 the angle of contact immediately after coating was high because there was too little of the alkylsulfosuccinaic acid salt (surfactant) (c) component and the brightness had fallen after exposure for 1 month and staining was established. In Comparative Example 3 the durability of the coated layer of the agent for a treatment to impart stain resistance was inadequate because there was no hydrolysis catalyst (b) component and staining was observed of exposure for 3 months. In Comparative Example 4 the brightness of the paint film had fallen after exposure for both 1 month and 3 months because there was no agent for a treatment to impart stain resistance and there was pronounced staining.

1. An agent for imparting stain resistance to top-coat paint films, the agent comprising
(a) from 3 to 10 mass % of a compound represented by Formula (1) or a partial hydrolysis condensate thereof, wherein Formula (1) is
R¹—(OCH₂CH₂)ₙ—O—Si(OR²)₃
wherein R¹ is an alkyl group having 1 to 6 carbon atoms or is a hydrogen atom, R² may be the same or different and is an alkyl group having 1 to 6 carbon atoms and n is an integer value from 2 to 4,
(b) from 0.01 to 1 mass % of a catalyst with which the (a) component can be hydrolyzed,
(c) from 0.5 to 3 mass % of an alkylsulfosuccinic acid salt based surfactant and
(d) from 86 to 96.49 mass % of an alcohol-based solvent which has not more than 3 carbon atoms.

2. A method for imparting stain resistance to top-coat paint films comprising
coating the agent of claim 1 onto a top-coat paint film of a painted product and drying the coated agent naturally.

3. The agent of claim 1 wherein component (a) is made by reacting a compound of formula:
R^{1a}—(OCH₂CH₂)ₙ—OH
where R^{1a} is an alkyl group having 1 to 6 carbon atoms and n is an integer value from 2 to 4, with a compound of formula
Si(OR²)₄
or a partial hydrolysis condensate thereof, wherein R² may be the same or different and is an alkyl group having 1 to 6 carbon atoms.

4. The agent of claim 3, wherein the compound of formula Si(OR²)₄ is selected from the group consisting of tetramethoxysilane, tetraethoxysilane, tetrapropoxysilane, tetraisopropoxysilane, tetrabutoxysilane, tetraisobutoxysilane, combinations thereof, and the partial hydrolysis condensates obtained by partially hydrolyzing one of these individually or two or more types in combination.

5. The agent of claim 3, wherein the compound of formula R^{1a}—(OCH₂CH₂)ₙ—OH is selected from the group consisting of diethylene glycol, triethylene glycol, tetraethylene glycol, diethylene glycol mono-methyl ether, triethylene glycol mono-methyl ether, tetraethylene glycol mono-methyl ether and combinations thereof.

6. The agent of claim 1, wherein component (b) is at least one of an organo-tin compound, an organic acid, or an amine.

7. The agent of claim 6, wherein component (b) is selected from the group consisting of dibutyl-tin diacetate, dibutyl-tin dilaurate, dibutyl-tin dimaleate, tin di-octylate, dibutyl-tin oxide, p-toluenesulfonic acid, dodecylbenzenesulfonic acid, dinonylnaphthalenesulfonic acid, dinonylnaphthalenedisulfonic acid, methanesulfonic acid, triethylamine, dimethylbenzylamine, dimethylethanolamine, dimethyllaurylamine, dibutylamine, di-2-ethylhexylamine, tetramethylbutanediamine, pyridine, and triethanolamine.

8. The agent of claim 1 wherein component (c) is selected from the group consisting of sodium dihexylsulfosuccinate, potassium dihexylsulfosuccinate, ammonium dihexylsulfosuccinate, sodium dioctylsulfosuccinate, potassium dioctylsulfosuccinate, and ammonium dioctylsulfosuccinate.

9. The agent of claim 1, wherein component (d) is selected from the group consisting of methanol, ethanol, n-propanol and isopropanol.
